(19) United States
(12) Patent Application Publication
(10) Pub. No.: US 2024/0302578 A1
(43) Pub. Date: Sep. 12, 2024

(54) APPARATUSES, SYSTEMS, AND METHODS FOR VARIABLE PROFILE LENSES

(71) Applicant: Meta Platforms Technologies, LLC, Menlo Park, CA (US)

(72) Inventors: Dongmin Yang, San Jose, CA (US); Yi Zhou, San Jose, CA (US); Yizhi Xiong, Foster City, CA (US); Fei Liu, Los Altos, CA (US); Abhishek Dhanda, San Ramon, CA (US); Michael Okincha, San Jose, CA (US); Linsen Bie, San Francisco, CA (US); Honghong Peng, Los Altos, CA (US); Zhaochun Yu, Wilmette, IL (US); Lidu Huang, Danville, CA (US); Shaomin Xiong, Newark, CA (US); Gabriel Molina, Sunnyvale, CA (US); Pablo Castillo Canales, San Ramon, CA (US); Peng Chen, Fremont, CA (US); Danni Luo, Sunnyvale, CA (US); Eddie Alex Azuma, Pleasanton, CA (US)

(21) Appl. No.: 18/414,040

(22) Filed: Jan. 16, 2024

Related U.S. Application Data
(60) Provisional application No. 63/488,708, filed on Mar. 6, 2023.

(51) Int. Cl. G02B 3/14

(52) U.S. Cl. CPC G02B 3/14

(57) ABSTRACT

A lens with an adjustable surface profile can include an actuatable layer, an optical layer, and at least one actuator. The optical layer can include a deformable polymer, and the actuatable layer can have a surface profile that is configured to be adjustable using the at least one actuator. The optical layer, meanwhile, can be configured to deform when the at least one actuator actuates the actuatable layer.

### CROSS REFERENCE TO RELATED APPLICATION

This application is a continuation of U.S. Provisional Application No. 63/488,708 filed Mar. 6, 2023, the disclosures of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a cutaway schematic diagram of an example lens with a variable surface profile.

FIG. 2 is a cutaway schematic diagram of an example lens with a variable surface profile in an alternate state.

FIG. 3 is a schematic diagram of an example focusing array that incorporates a variety of optics for directing and focusing light.

FIG. 4 is a schematic side view of an example lens with a variable surface profile.

FIG. 5 is a schematic side view of an example variable surface profile lens being acted on by an actuator.

FIG. 6 is a schematic diagram of an example two-part lens array that incorporates a lens with a variable surface profile.

FIG. 7 is an additional schematic diagram of an example two-part lens array that incorporates a lens with a variable surface profile.

FIG. 8 is a side cutaway diagram of an example lens with a variable surface profile mounted on a substrate.

FIG. 9 is an illustration of exemplary augmented-reality glasses that may be used in connection with embodiments of this disclosure.

FIG. 10 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

In some examples, an AR/VR device may include one or more cameras to obtain external images relating to the device environment. It is generally desirable to minimize the weight of a head-mounted device (HMD) and hence fixed-focus cameras may be used to provide arguably sufficient quality images, though with a limited depth of field such as between 40 cm-50 cm and infinity. A fixed-focus camera may require trading off the camera image quality for near and distant objects as it may not be possible to obtain the highest quality images for both near and distant objects using a fixed-focus camera. Further, high or low temperatures may reduce image quality for a fixed-focus camera. Image quality may be unacceptable outside of the fixed depth of field, for example, for objects in the environment located at a distance less than 40 cm-50 cm from the device.

Meanwhile, conventional adjustable focus lenses may not meet miniaturization, size, or power consumption requirements for HMDs or other devices where such constraints are in play, such as mobile devices, phones, handheld game consoles, smart watches, smart glasses, etc. For example, traditional camera focus systems may include motors and other moving or mechanical parts that can cause reliability issues, add undesirable bulk, increase the device power consumption, generate electromagnetic interference, and/or generate particles that can degrade image quality and/or device reliability.

The present disclosure is generally directed to apparatuses, systems, and methods for variable profile lenses. . As will be explained in greater detail below, embodiments of the present disclosure may enable a camera or other device to focus light using a minimum of moving parts in a compact form factor. As will be described in greater detail below, variable profile lenses that can be adjusted using, for example, piezoelectric actuators, can provide a variety of important camera or lens group functionality while meeting the size, power consumption, and/or reliability requirements for small devices such as HMDs for VR/AR.

In some examples, a surface profile variable lens may provide one or more of the following advantages: allowing an ultra-compact element, a fast response time (e.g., approximately 2 ms or less), ultra-low power consumption (e.g., less than 10 mW, such as approximately 6 mW), a large focus range (e.g., approximately 10 cm to infinity), a constant field of view (e.g., no zoom bump), reduced or eliminated electromagnetic interference issues, reduced gravity impact in different postures (e.g., orientation-independent lens performance), and/or no moving parts (e.g., eliminating concerns regarding wear, lifetime, or particle generation).

Example aspects may include at least one or more of the following features: fast (e.g., effectively instantaneous refocus), extended DOF (eDOF) where all elements within the environment may be brought in focus by fusing multiple frames obtained with different focal lengths, or shallow DOF (sDOF) which provides a bokeh effect that may be desirable, for example, in portrait mode, offline refocus, depth measurement, optical zoom, and/or optical image stabilization.

Features from any of the embodiments described herein may be used in combination with one another in accordance with the general principles described herein. These and other embodiments, features, and advantages will be more fully understood upon reading the following detailed description in conjunction with the accompanying drawings and claims.

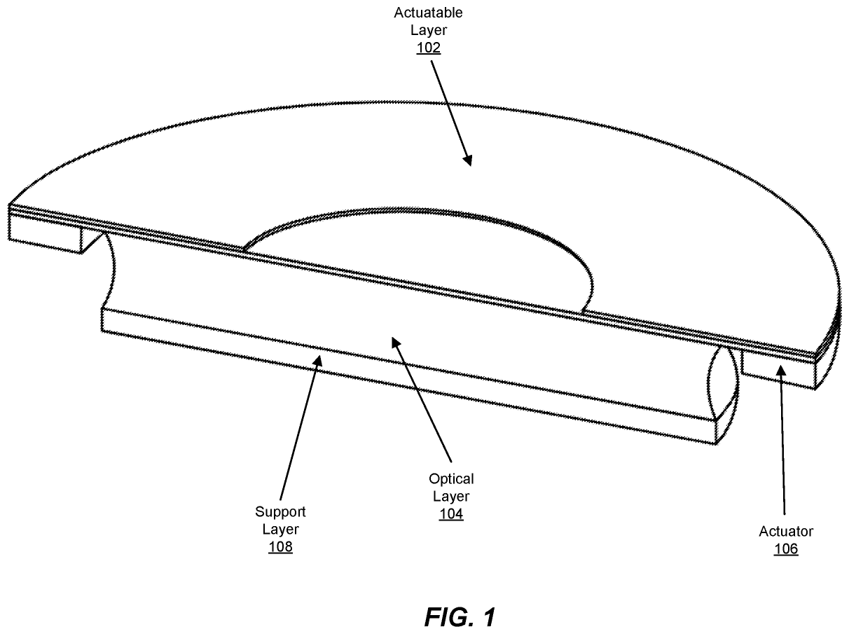

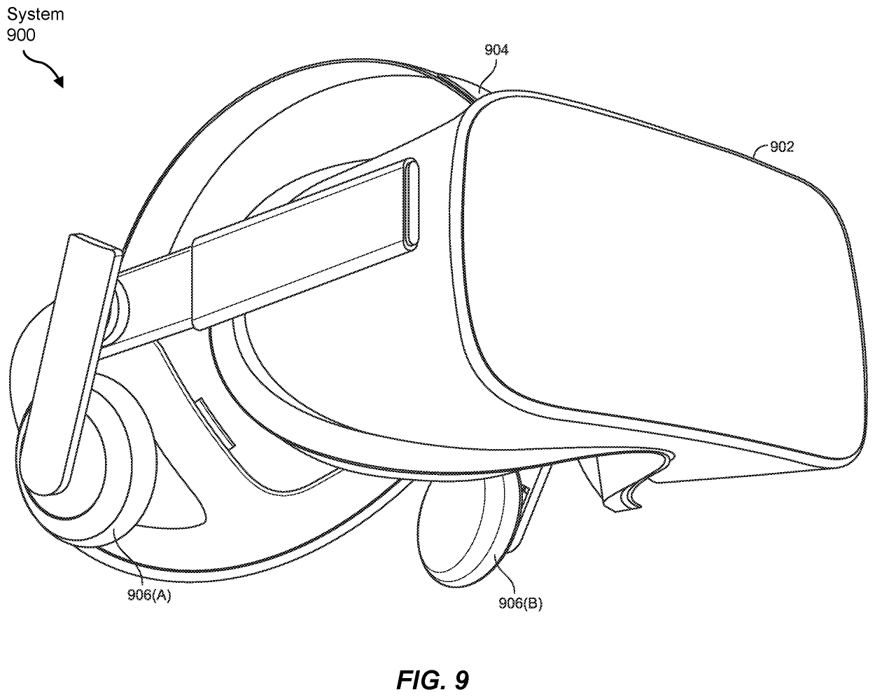

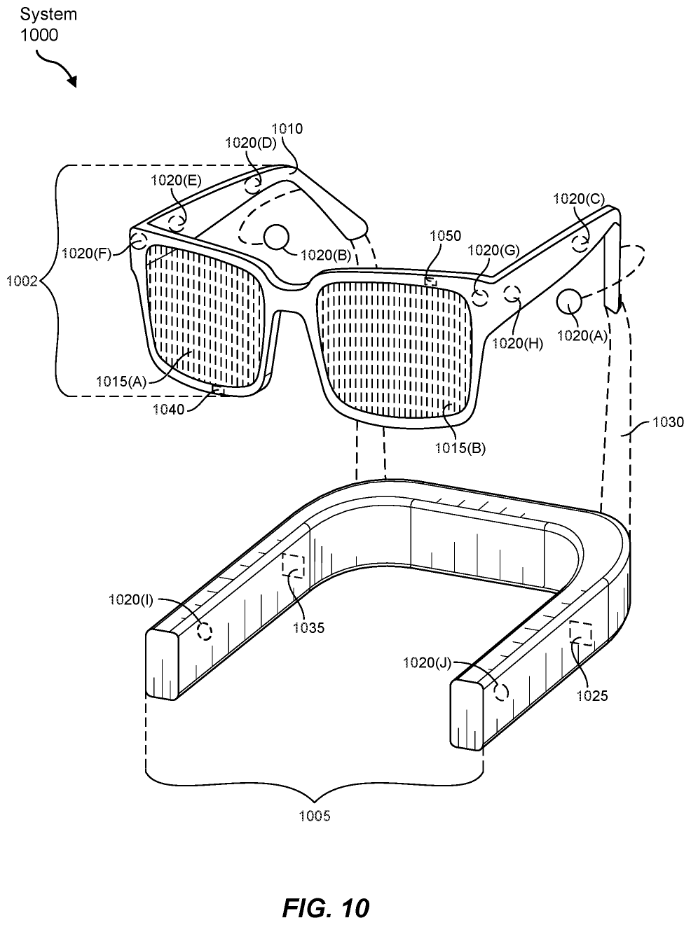

The following will provide, with reference to FIGS. 1-8, detailed descriptions of variable profile lenses as well as apparatuses and systems that can incorporate variable profile lenses. Detailed descriptions of example augmented reality devices that can include variable profile lenses are provided in connection with FIGS. 9 and 10.

FIG. 1 is a cutaway schematic diagram of an unactuated variable profile lens, sometimes referred to as a variable lens. As illustrated in FIG. 1, such a lens can include an actuatable layer 102 that can be acted upon by actuator 106 to change the surface profile of optical layer 104. The entire lens can be supported by support layer 108. Optical layer 104 is located between actuatable layer 102 and support layer 108 (e.g., in direct physical contact with both layers) such that when actuator 106 acts upon actuatable layer 102, movement of actuatable layer 102 causes a physical deformation in optical layer 104, thereby changing the refractive properties of optical layer 104. In some embodiments, the refractive index of optical layer 104 can match the refractive index of actuatable layer 102 and/or support layer 108 to prevent distortions caused by light passing through the different layers.

Actuatable layer 102 and support layer 108 are sometimes referred to as first and second substrate layers. These layers may have a substantially disk-shaped form. Actuatable layer 102 can have a generally ring-shaped form factor that has an inner radius and an outer radius, with a central aperture defined by the inner radius. Actuatable layer can be acted upon at its periphery by actuator 106. In some embodiments, and as illustrated in FIG. 1, the variable lens can include an additional portion of actuatable layer 102 around the periphery that extends outwards beyond optical layer 104. Actuator 106 can be configured to urge all or a portion of actuatable layer 102 towards or away from support layer 108 depending on the desired optical properties of the variable lens.

Actuatable layers and substrate layers of variable lenses can be formed from a variety of materials, such as glass, with suitable optical properties for a lens. In some embodiments, one layer may be thinner than the other. Some or all of these layers can include at least one of a glass (e.g., a silica glass), a ceramic, a polymer, a semiconductor, an inorganic material (e.g., an oxide), or other material.

Optical layers of variable lenses can likewise be formed from a variety of materials. In some examples, the optical layer may include a deformable polymer, such as an elastic, viscoelastic or other resilient polymer. An optical layer may include one or more polymers such as a siloxane polymer (e.g., PDMS, polydimethylsiloxane, or other silicon-containing polymer), an elastomer (e.g., a thermoplastic elastomer), or another deformable polymer. In this context, a deformable polymer may conform to modifications of the surface profile of the variable lens, such as within less than one second, and in some examples within less than 100 ms. In some examples, the optical layer may include a fluid (such as a liquid), a foam, an emulsion, a micellar solution, or other fluid material that may be contained within an enclosure at least partially formed by the first and second layers. In some examples, an optical layer may include a liquid component, such as a high refractive index liquid (e.g., an index matching fluid suitable for use with the glass layers if present). In some examples, a polymer network may extend through a liquid component. The mean refractive index of the composite optical layer material (or any optical layer) may match one or both of layers located proximate or adjacent the optical layer (e.g., at least one glass layer). In some examples, a high refractive index liquid may include a phthalate such as a dialkyl phthalate (e.g., dimethyl phthalate or diethyl phthalate). High index liquids may include aromatic organic liquids, isotropic phases of liquid crystals, alcohols, and the like (e.g., a phthalate in a liquid mixture with an alcohol such as ethanol or methanol). In some examples, a high refractive index liquid may have a refractive index of at least 1.4 for at least one wavelength of visible light at 20 degrees C.

In some embodiments, the optical layer can include a membrane layer to help contain and shape the material of the optical layer. In some examples, a membrane layer may include at least one of a glass (e.g., a silica glass), a ceramic, a polymer, a semiconductor, an inorganic material (e.g., an oxide), or other material. The membrane layer may be generally transparent, for example, transmitting at least one wavelength of visible light through the membrane with an intensity loss of less than 10%. In some examples, a membrane may have an appreciable color tint. The color tint may be compensated by adjusting the color balance of the image displayed to a user. In some examples, a membrane layer or actuatable layer may have a thickness that is 50% or less than the thickness of a support layer. The profile of the membrane layer may be adjusted using one or more actuators (e.g., micro-actuators or other control elements) that may be located (or act on the membrane layer) near the periphery of the membrane layer (e.g., proximate the edge of the membrane layer). A membrane may have a thickness less than 1 mm, such as a thickness in the range 25 microns-1 mm, such as in the range 50 microns-500 microns.

In some contexts, a membrane may have an adjustable profile that allows a discernable adjustment of an optical parameter, such as an optical power change of at least 0.1 diopter. In some examples, a layer (e.g., a membrane layer or other layer) may have an adjustable tilt, for example, a tilt that may provide at least a 3 degrees deviation in a light beam direction. A piezoelectric film located on the outer surface of a membrane layer (e.g., a thin glass plate) may allow the membrane layer to be tilted and/or otherwise modified (e.g., curved) to adjust the optical properties of the variable lens. In these examples, the membrane layer may serve as the actuatable layer, i.e., be directly actuated by actuators.

In some examples, the membrane surface (upper surface as illustrated) may be tilted relative to the support layer, which may also be referred to as a substrate. The support layer may be normal to the optical axis of the optical assembly. The tilted membrane surface may refract rays passing through the optical assembly, may modify the focal length of the optical assembly, and in some examples may be used to provide astigmatism corrections, provide prism lenses, or provide other optical parameter adjustment(s). In some examples, an actuator on one side of the membrane layer may urge the membrane layer towards or away from the support layer. An actuator on an opposite side of the membrane layer may be unactuated or urge the membrane layer in an opposite direction.

In some examples, the actuators described herein can include one or more transducers, such as piezoelectric transducers. These transducers may be used to apply a force to the membrane layer, for example, urging the periphery of the membrane layer towards the support layer or pulling the periphery of the membrane layer away from the support layer. In some examples, transducers may be arranged around the periphery of the membrane layer. In some examples, transducers may be used to induce a concave, planar, or convex surface in the membrane layer. For example, the lens assembly may include one or more fixed-focus lenses having a particular optical power, and the optical power of the lens assembly may be adjusted using one or more variable lenses. In some examples, electrostatic attraction (or electrostatic repulsion) between electrodes may be used adjust the membrane profile, where the membrane profile may include curvature and/or tilt components. In some embodiments, an actuator can include a piezoelectric film that covers one surface of the optical layer/polymer layer and deforms the polymer layer in response to receiving electrical signals from a control unit.

In some examples, an actuator can be configured to apply forces to the periphery of a membrane layer. For example, an actuator can be configured to push, pull, compress, expand, warp, or otherwise apply forces to an actuatable layer of a variable lens to cause the actuatable layer to apply deformation forces to the optical layer.

In some examples, the optical layer may further include a membrane layer (such as flexible membrane, e.g., an elastic membrane) and the ring-shaped layer may be, include, or support an actuator layer. in some examples, the optical layer may be enclosed in a membrane, such as a flexible membrane.

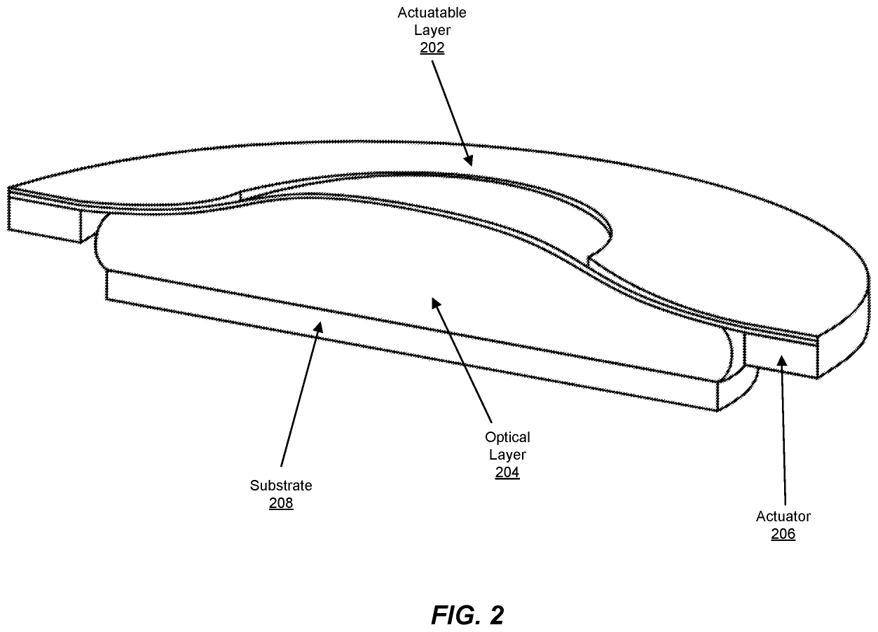

FIG. 2 is a cutaway illustration of a variable lens in which an actuator 206 has acted upon actuatable layer 202 to deform optical layer 204 through the central aperture of actuatable layer 202 due to the compression force caused by urging actuatable layer 202 towards substrate 208. In this example, applying a downwards force evenly around the edges of actuatable layer 202 has compressed optical layer 204 and caused a central portion of optical layer 204 to protrude upwards, for example, through an aperture in actuatable layer 202. This deformation of optical layer 204 may increase the optical power of an example variable lens and hence increase the optical power of a lens assembly including the variable lens. Although this example illustrates actuation force being applied to actuatable layer 202 evenly across actuatable layer 202, some variable lenses can include groups of actuators, actuator arrays, tunable actuators, etc. that can apply forces unevenly to actuatable layer 202, as will be described in greater detail below.

The combination of FIGS. 1 and 2 illustrate one type of variable lens in which actuation of the actuatable layer can cause a change in the magnification power of the variable lens. However, and as will be described in greater detail below other configurations of variable lens can be applied to different situations. In some examples, a variable lens can be configured to change a curvature of the lens surface and thereby alter a magnification property of the lens. In some embodiments, a variable lens can be configured to change the angle or tilt of a surface of the lens. In further embodiments, a variable lens can be configured to change the curvature of the lens, the angle of the lens, or both the curvature and the angle of the lens simultaneously.

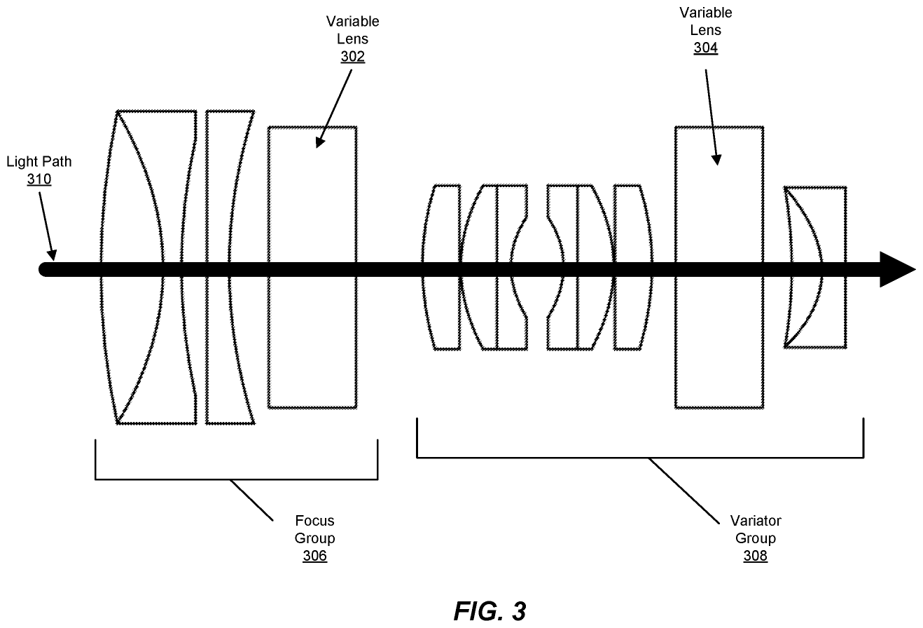

FIG. 3 shows an example optical assembly including a surface profile variable lens (or “variable lens”) that may be used for optical zoom applications in devices such as cameras. The lens assembly illustrated in FIG. 3 includes a focus group 306 that includes a variable lens 302. Focus group 306 can be configured to adjust the focus of the overall lens assembly. The lens assembly further includes a variator group 308 that may be used to adjust the zoom (e.g., the field of view) of the lens assembly by affecting light traveling along light path 310. The variable lenses included in each lens group may have similar or different configurations, depending on the needs of the overall optical assembly.

The components of an optical assembly such as the one illustrated in FIG. 3 can work together in concert to adjust, focus, and/or direct light through the optical assembly. Including variable profile lenses in these assemblies can allow the optical assembly to perform operations such as image capture, zoom, auto-focus, and/or optical image stabilization by adjusting the variable profile lenses by, for example, applying mechanical force and/or electrical signals to at least one region of the variable profile lens. In some embodiments, an optical assembly can allow a camera to capture auto-focused external images of the environment and transmit corresponding camera signals to a controller, processor, or other computing device. Additionally or alternatively, a camera and/or a camera array can obtain images using a number of different focal planes and/or focus locations to facilitate producing images with a wide angle of view and/or a wide depth of field. Adjustable lenses can also improve image quality over fixed-focus cameras by enabling the camera to adjust in response to ambient lighting conditions, indications of focus objects, etc. These improvements provided by variable lenses over fixed focus lenses can be especially noticeable when attempting to capture images of objects at a distance less than 40 cm from the device.

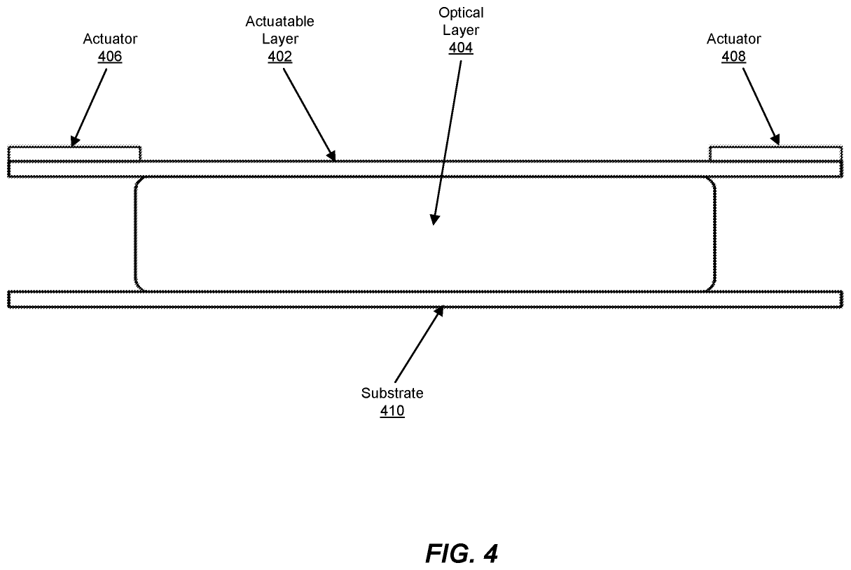

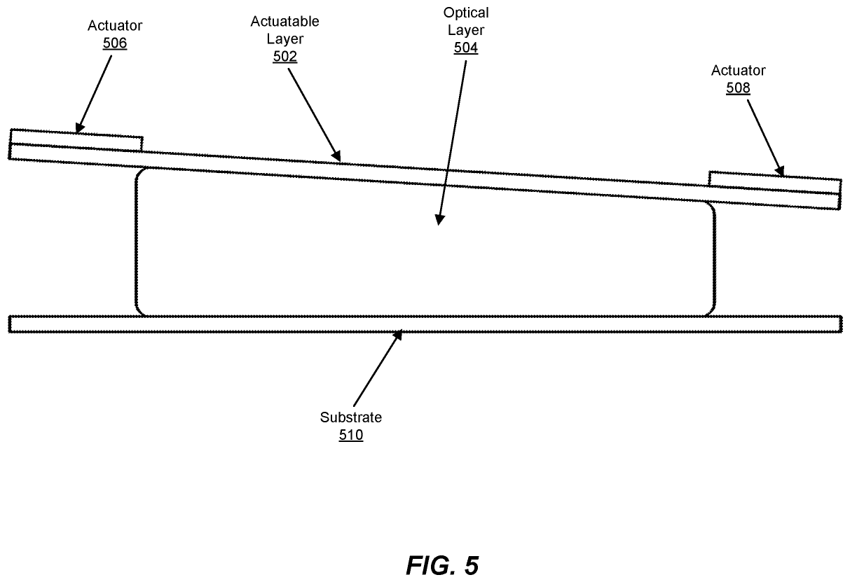

FIGS. 4 and 5 illustrate a variable lens configured to change the angle of the lens, as mentioned above. In these examples, providing a signal to/an actuator, such as a piezoelectric actuator (such as a PZT or lead zirconate titanate film), cause the actuator to push (or pull) on one side of a first layer (e.g., a glass plate) to change the surface tilt angle of a variable lens. Any type of actuator may be used such as a piezoelectric actuator or other actuator. In some examples, a second actuator may be used to control a second side of the first layer, for example, to tilt the first layer in the opposite direction. In some examples, a plurality of actuators may be located around the first layer and used to obtain a desired tilt angle in a desired tilt direction. A tilt angle may be in the range of 0.1-10 degrees. The tilt direction may be along a direction between any two groupings of actuators, such as a pair of actuators. In some examples, an actuator may include one or more piezoelectric layers, such as inorganic piezoelectric layers or polymer piezoelectric layers. In some examples, an actuator may include one or more electroactive polymer layers.

In the specific example of FIG. 4, an optical layer 404 is sandwiched between an actuatable layer 402 and a substrate 410. Actuatable layer 402 and substrate 410 may be substantially optically transparent and/or have refraction indices that are substantially similar to that of optical layer 404 to ensure that the entire assembly acts as a single lens. Additionally, an actuator 406 and an actuator 408 are arranged in contact with actuatable layer 402 such that actuators 406 and 408 are able to apply forces to actuatable layer 402 when activated. In the above-described example where actuator 406 and actuator 408 are piezoelectric actuators, the variable lens illustrated in FIG. 4 may represent a state of the variable lens when no voltages are being applied to the actuators, i.e., a rest or neutral state. Furthermore, in addition to the two actuators illustrated in FIG. 4, other actuators may be positioned on, under, around, or otherwise in contact with actuatable layer 402 to facilitate manipulation of actuatable 402 to cause changes in the optical properties of optical layer 404.

FIG. 5 is a side view schematic of a variable lens in which the actuators have been activated to apply forces to the actuatable layer. In the example of FIG. 5, optical layer 504 is disposed between actuatable layer 502 and substrate 510 much as optical layer 404 in FIG. 4. A combination of forces provided by actuators 506 and 508 has caused actuatable layer 502 to tilt relative to the above-described rest state, which alters the optical properties of optical layer 504. As will be described in greater detail below, this tilting of the surface of optical layer 504 can change the angle of incidence of light passing through the variable lens, which can be used to provide optical image stabilization (OIS) for cameras and the like. Actuators 506 and 508 can act individually or in concert with other actuators to facilitate adjustment of actuatable layer 502 and, by extension, the optical properties of optical layer 504. For example, activation of actuator 506 may cause it to pull on a section of actuatable layer 502. Additionally or alternatively, actuation (or negative actuation) of actuator 508 may result in a pushing force being applied to actuatable layer 502.

The light deflection caused by changing the angle of incidence may be determined using Snell's Law (n₁ sin θ₁=n₂ sin θ₂) where θ₁ is the angle of incidence in a first medium and θ₂ is the angle of refraction in a second medium. For example, the first medium may be air so that n₁=1. The second medium may effectively be the optical layer (e.g., if the actuatable layer and any substrate layers each have parallel surfaces or otherwise do not contribute to light redirection). In some examples, the refractive index of the second medium (e.g., the optical layer of a variable lens) may be at least 1.4 for at least one wavelength of visible light at 20 degrees C. The deflection may be adjusted by adjusting the tilt of a layer (e.g., a support layer, membrane layer, or actuatable layer) of a variable lens.

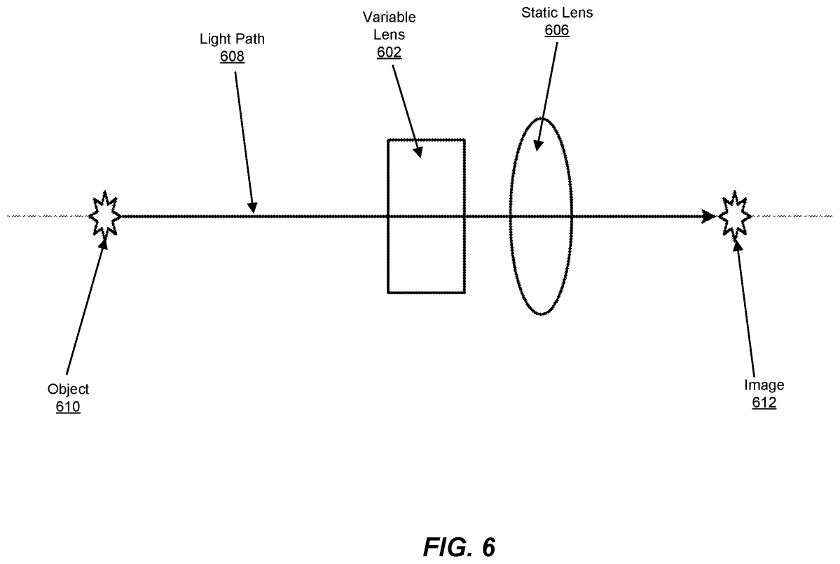

FIG. 6 is a simplified schematic diagram showing an example lens assembly that includes a variable lens 602 as described above and a static lens 606 (i.e., non-adjustable lens) positioned to affect light path 608 of light reflecting off of object 610 to produce an image 612 at, for example, a camera sensor. Motion of object 610 and/or of the lens assembly may result in instability in image 612 (e.g., jitter, vibration, etc.) that may affect the quality of images recorded by a camera that incorporates the lens assembly of FIG. 6.

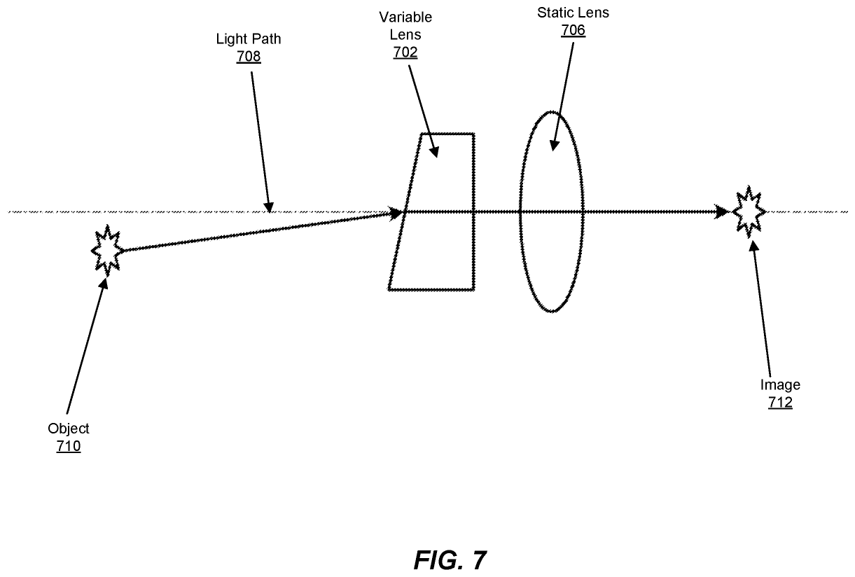

However, a variable lens can provide optical image stabilization functions for compact, low-power camera devices. As illustrated in FIG. 7, object 710 is not in line with the lens assembly as indicated by light path 708. However, tilting the incident surface of variable lens 702 can adjust light path 708 before it passes through static lens 706 to stabilize the position of image 712 despite the relative motion of object 710.

The combined examples of FIGS. 6 and 7 describe the function of variable lenses in the context of optical image stabilization in a camera. OIS functionality can be facilitated by a variety of other components. In some examples, a device may include one or more accelerometers that may provide accelerometer signals to a controller. The accelerometer signals may provide motion data related to a motion of the device. The controller may provide a suitable control signal to the variable lens (e.g., to actuators of the variable lens) to compensate for the motion of the device. The control signal may accordingly adjust the orientation and/or surface profile of the actuatable layer, and thereby alter the optical properties of the optical layer.

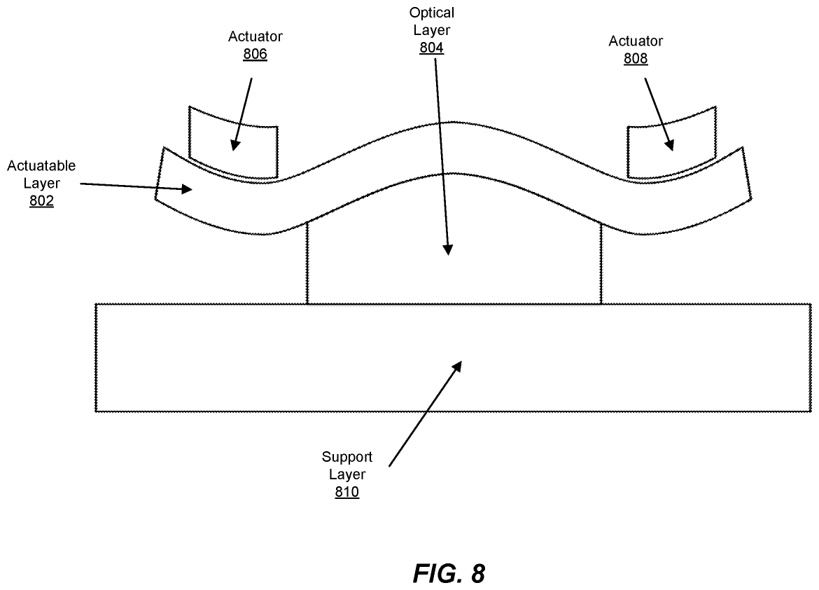

FIG. 8 is a side-view cutaway diagram of an example variable lens. In this example, optical layer 804 is disposed between an actuatable 802 and support layer 810. Actuators 806 and 808 are positioned along outside edges of actuatable layer 802 so that actuation of the actuators cause movement of actuatable layer 802, which may cause changes in the shape and/or positioning of optical layer 804 by virtue of actuatable layer 802 being in physical contact with actuatable layer 802 and supported by support layer 810. In some examples, actuatable layer 802 may be generally rigid, and may have a thickness between 500 microns and 2 mm. A generally rigid adjustable surface may allow tilt adjustments (e.g., for image stabilization) but may allow less focal length adjustment than a more flexible membrane.

As described above, one or more variable lenses can be included in cameras to provide a variety of functions to the camera. In these examples, the camera can include a controller that is configured to receive camera signals from the camera and provide an external image signal and/or an augmented reality element signal based on information received from the camera. For example, a camera incorporated into a VR headset may record images of the surrounding environment, using variable lenses to focus and stabilize the images. The camera may then send the recorded images to the controller, which can send the image information to a display of the VR headset that displays the external image along with any other relevant VR elements such as overlays, callouts, virtual objects, and the like.

Such a VR headset can also include an accelerometer signal that provides acceleration information to the controller, enabling the controller in turn to send signals to the actuators of the one or more variable lenses to stabilize, focus, or zoom the images recorded by the camera.

In further embodiments, the variable lenses described herein can be incorporated into eye tracking components of a head-mounted device (HMD). For example, an HMD can include cameras positioned and configured to record images of a user's eyes. As may be appreciated from the above descriptions, eye tracking cameras may benefit from optical image stabilization, zoom, and/or focus functions that can be provided by variable lenses.

Although the above examples are largely directed to cameras and other devices that receive light, variable lenses can also be incorporated into devices that emit light, such as projectors, to focus, move, or stabilize images. For example, an HMD that incorporates a variable lens into the display components of the HMD and/or optical assemblies between the display surface and the user's eyes can adjust the focus of images provided to a user's eyes to allow users to compensate for, e.g., any necessary vision correction such as nearsightedness without necessitating use of other vision-correcting devices such as contact lenses.

As described above, cameras and other optical assemblies can incorporate variable profile lenses that can change their surface profiles in response to receiving electrical signals. These electrical signals can activate one or more actuators (such as piezoelectric actuators) that change the position of an actuatable layer that can press or pull an optical layer to cause deformations in the optical layer. These deformations of the optical layer can cause a change in the overall surface profile of the variable lens to provide the desired effect. Different configurations of actuatable layers, actuators, and/or optical layers can produce variable lenses that are capable of providing a variety of optical adjustments, such as zoom, OIS, and/or focus adjustments in a compact form factor with a minimum of mechanical moving parts, thereby reducing the overall size and power consumption of cameras and/or other optical assemblies versus other types of optical assemblies. Using piezoelectric actuators in particular may reduce particulates and/or electromagnetic interference that would be caused by motors or other methods of adjusting an optical assembly.

### EXAMPLE EMBODIMENTS

Example 1: An apparatus that includes a lens with an adjustable surface profile can include an actuatable layer, an optical layer, and at least one actuator. The optical layer can include a deformable polymer, and the actuatable layer can have a surface profile that is configured to be adjustable using the at least one actuator. The optical layer, meanwhile, can be configured to deform when the at least one actuator actuates the actuatable layer.

Example 2: The apparatus of Example 1 in which the actuators include piezoelectric actuators.

Example 3: The apparatus of any of Examples 1 and 2 in which the actuatable layer has a ring-shaped form factor defined by an outer radius and has an inner aperture defined by an inner radius.

Example 4: The apparatus of any of Examples 1-3 in which actuation of the actuatable layer causes a portion of the optical layer to protrude through the inner aperture of the actuatable layer.

Example 5: The apparatus of any of examples 1-4 in which adjusting the surface profile of the actuatable layer causes deformation of the optical layer.

Example 6: The apparatus of any of examples 1-5 in which the variable lens is a camera lens for a camera that is configured to receive light from an external environment and provide a camera signal.

Example 7: The apparatus of any of examples 1-6 in which the variable lens is configured to provide a camera with at least one of an auto-focus, optical zoom, or optical image stabilization function.

Example 8: The apparatus of any of examples 1-7 in which the apparatus includes a controller that is configured to receive a camera signal from a camera and provide an external image signal based on the camera signal. The controller is also configured to provide an augmented reality element signal. This apparatus also includes a display that is configured to show an augmented reality image element based on the augmented reality element signal, and an external image based on the external image signal.

Example 9: The apparatus of any of examples 1-8 in which the apparatus includes an accelerometer that provides accelerometer signals to a controller to facilitate application of an auto-focus, optical zoom, or optical image stabilization function to at least one of the external image or the augmented reality image element.

Example 10: The apparatus of any of examples 1-9 in which the variable lens is a camera lens for a camera that is configured to receive images of a user's eye.

Example 11: The apparatus of any of examples 1-10 in which a refractive index of the optical layer matches a refractive index of the actuatable layer.

Example 12: A system that includes a lens with an adjustable surface profile can include an actuatable layer, an optical layer, and at least one actuator. The optical layer can include a deformable polymer, and the actuatable layer can have a surface profile that is configured to be adjustable using the at least one actuator. The optical layer, meanwhile, can be configured to deform when the at least one actuator actuates the actuatable layer.

Example 13: The system of claim 12 in which the variable lens is a camera lens, and further including a light detector of the camera that is configured to receive light that passes through the variable lens and output a camera signal.

Example 14: The system of either of Examples 12 or 13 in which the variable lens is configured to provide the camera with at least one of an auto-focus, an optical zoom, or an optical image stabilization function.

Example 15: The system of any of Examples 12-14 in which the system includes a controller that is configured to receive a camera signal from a camera and provide an external image signal based on the camera signal. The controller is also configured to provide an augmented reality element signal. This apparatus also includes a display that is configured to show an augmented reality image element based on the augmented reality element signal, and an external image based on the external image signal.

Example 16: The system of any of Examples 12-15 in which the system includes an accelerometer that provides accelerometer signals to a controller to facilitate application of an auto-focus, optical zoom, or optical image stabilization function to at least one of the external image or the augmented reality image element.

Example 17: The system of any of Examples 12-16 in which the system includes a light emitter that is configured to emit light that is directed through the variable lens.

Example 18: The system of any of Examples 12-17 in which the actuatable layer has a ring-shaped form factor defined by an outer radius and has an inner aperture defined by an inner radius.

Example 19: The system of any of Examples 12-18 in which actuation of the actuatable layer causes a portion of the optical layer to protrude through the inner aperture of the actuatable layer.

Example 20: A method for using a variable lens can include actuating, by at least one actuator of a variable lens, an actuatable layer of the variable lens. The variable lens can include an actuatable layer, an optical layer, and the at least one actuator. The optical layer can include a deformable polymer, and the actuatable layer can include a surface profile that is configured to be adjusted using the at least one actuator. The optical layer can also be configured to deform when the at least one actuator acts on the actuatable layer. Deformation of the optical layer and/or alteration of the surface profile of the actuatable layer can cause the optical layer to refract light in a manner dependent on the activity of the at least one actuator on the actuatable layer.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality device 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium-ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus comprising a variable lens comprising:
an actuatable layer;
an optical layer; and
at least one actuator,
wherein:
the optical layer includes a deformable polymer;
the actuatable layer has a surface profile that is configured to be adjustable using the at least one actuator; and
the optical layer is configured to deform when the at least one actuator actuates the actuatable layer.

2. The apparatus of claim 1, wherein the at least one actuator comprises a piezoelectric actuator.

3. The apparatus of claim 1, wherein the actuatable layer comprises a ring-shaped form factor defined by an outer radius and having an inner aperture defined by an inner radius.

4. The apparatus of claim 3, wherein actuation of the actuatable layer causes a portion of the optical layer to protrude through the inner aperture of the actuatable layer.

5. The apparatus of claim 1, wherein adjusting the surface profile of the actuatable layer comprises deforming the optical layer.

6. The apparatus of claim 1, wherein the variable lens is a camera lens for a camera that is configured to receive light from an external environment and to provide a camera signal.

7. The apparatus of claim 6, wherein the variable lens is configured to provide the camera with at least one of an auto-focus, an optical zoom, or an optical image stabilization function.

8. The apparatus of claim 6, further comprising:
a controller configured to receive the camera signal and to provide an external image signal based on the camera signal and to provide an augmented reality element signal; and
a display configured to show an augmented reality image element based on the augmented reality element signal and an external image based on the external image signal.

9. The apparatus of claim 8, further comprising at least one accelerometer that provides accelerometer signals to the controller to facilitate application of at least one of an auto-focus, an optical zoom, or an optical image stabilization function to at least one of the augmented reality element or the external image.

10. The apparatus of claim 1, wherein the variable lens is a camera lens for a camera that is configured to receive images of a user's eye.

11. The apparatus of claim 1, wherein a refractive index of the optical layer matches the refractive index of the actuatable layer.

12. A system comprising:
a variable lens comprising:
an actuatable layer;
an optical layer; and
at least one actuator,
wherein:
the optical layer includes a deformable polymer;
the actuatable layer has a surface profile that is configured to be adjustable using the at least one actuator; and
the optical layer is configured to deform when the at least one actuator actuates the actuatable layer.

13. The system of claim 12:
wherein the variable lens comprises a camera lens for a camera; and
further comprising a light detector of the camera that is configured to receive light that passes through the variable lens and output a camera signal.

14. The system of claim 13, wherein the variable lens is configured to provide the camera with at least one of an auto-focus, an optical zoom, or an optical image stabilization function.

15. The system of claim 13, further comprising:
a controller configured to receive the camera signal and to provide an external image signal based on the camera signal and to provide an augmented reality element signal; and
a display configured to show an augmented reality image element based on the augmented reality element signal and an external image based on the external image signal.

16. The system of claim 15, further comprising at least one accelerometer that provides accelerometer signals to the controller to facilitate application of at least one of an auto-focus, an optical zoom, or an optical image stabilization function to at least one of the augmented reality image element or the external image.

17. The system of claim 12, further comprising a light emitter that is configured to emit light that is directed through the variable lens.

18. The system of claim 12, wherein the actuatable layer comprises a ring-shaped form factor defined by an outer radius and having an inner aperture defined by an inner radius.

19. The system of claim 18, wherein actuation of the actuatable layer causes a portion of the optical layer to protrude through the inner aperture of the actuatable layer.

20. A method comprising:
actuating, by at least one actuator of a variable lens, an actuatable layer of the variable lens, the variable lens comprising:
the actuatable layer;
an optical layer; and
the at least one actuator;
wherein:
the optical layer includes a deformable polymer;
the actuatable layer has a surface profile that is configured to be adjustable using the at least one actuator; and
the optical layer is configured to deform when the at least one actuator actuates the actuatable layer;
thereby causing the optical layer to refract light in a manner dependent on activity of the at least one actuator on the actuatable layer.
